(19) United States
(12) Patent Application Publication
(10) Pub. No.: US 2015/0075074 A1
(43) Pub. Date: Mar. 19, 2015

(54) ARRANGEMENT

(71) Applicant: Niklas LÖFBERG, Sipoo (FI)

(72) Inventor: Niklas LÖFBERG, Sipoo (FI)

(73) Assignee: KONE CORPORATION, Helsinki (FI)

(21) Appl. No.: 14/549,028

(22) Filed: Nov. 20, 2014

Related U.S. Application Data
(63) Continuation of application No. PCT/FI2013/050498, filed on May 6, 2013.

(30) Foreign Application Priority Data
May 25, 2012 (FI) 20125563

(51) Int. Cl. E05F 15/20; E05F 15/18

(52) U.S. Cl. CPC E05F 15/2038; E05F 15/18; E05F 15/20
USPC 49/32

(57) ABSTRACT

The present invention discloses an automatic door system applicable to access control, which automatic door system comprises a door panel, which is disposed in connection with a wall structure, which separates a first space and a second space from each other. The automatic door system also comprises a locking device for the door panel, an opening pushbutton for the locking device, and a reader device of access cards that is in connection with an access control unit. The opening pushbutton and the reader device are integrated into a single module, which is disposed as a single entity in a wall structure or in a door panel.

### FIELD OF THE INVENTION

This application is a continuation of PCT International Application No. PCT/FI2013/050498 which has an International filing date of May 6, 2013, and which claims priority to Finnish patent application number 20125563 filed May 25, 2012, the entire contents of both which are incorporated herein by reference.

The invention relates to automatic doors. More particularly the invention relates to an automatic door system applicable to access control, which automatic door system is suited to access control in buildings.

### BACKGROUND OF THE INVENTION

In buildings there is often a need to arrange access control in such a way that only persons possessing an access permit can gain access into spaces subject to access control. A space is generally separated from other spaces with a wall or other corresponding obstacle. An automatic door is installed in a door opening that is in a wall, for opening which door a person needs an access card or other corresponding identifier. When a person presents his/her access card to a reader device that is in connection with the automatic door, the identification data read from the access card is transmitted to the access control system, which checks whether, on the basis of the identification data, the access rights needed by the person are valid. If the access control system ascertains that the person has valid access rights to move via the automatic door into the monitored space, it sends an opening command to the locking means of the automatic door. A monitored space is generally one that does not require an access card to exit the space. In order to exit a monitored space it is sufficient that the person presses an opening pushbutton in connection with the automatic door, as a consequence of which the locking device of the automatic door opens. In this way it can be ensured that all persons can exit the monitored space e.g. in the event of a fire.

An automatic door system typically comprises a door panel of the automatic door itself, a door panel of the automatic door, an opening pushbutton for the door panel, and also an access card reader device, which reader device is connected to a centralized access control system for the building. That being the case, an automatic door system can easily be complex and awkward to install, because there are numerous components to install and the cabling between them must be arranged in the structures of the building. Often it is also necessary to make cavities in the wall structures for the components to be installed.

### AIM OF THE INVENTION

The aim of the present invention is to eliminate, or at least to alleviate, the aforementioned drawbacks that occur in automatic door systems known in the art. The aim of the invention is also to achieve one or more of the following objectives:
an automatic door system, the components of which can be installed easily, without even making cavities in the wall structures;
an independently-operating, automatic door system applicable to access control.

### SUMMARY OF THE INVENTION

The call panel of the invention is characterized by what is disclosed in the characterization part of claim 1. Other embodiments of the invention are characterized by what is disclosed in the other claims. Some inventive embodiments are also presented in the drawings in the descriptive section of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. The features of the various embodiments can be applied within the framework of the basic inventive concept in conjunction with other embodiments.

The present invention discloses an automatic door system applicable to access control, which automatic door system comprises a door panel, which is disposed in connection with a wall structure, which separates a first space and a second space from each other. The automatic door system also comprises a locking device for the door panel, an opening pushbutton for the locking device, and a reader device of access cards that is in connection with an access control unit. According to the invention, the opening pushbutton and the reader device are integrated into a single module, which is disposed as a single entity in a wall structure or in a door panel. The term wall structure refers to any wall, fence or corresponding obstacle whatsoever in a building, which obstacle prevents people from freely moving from a first space into a second space. The aforementioned module is disposed in such a way that a person on the side of the first space can press the opening pushbutton for opening the locking means of the door panel and a person on the side of the second space can present his/her access card to the reader device for reading the data comprised in the access card. Presenting an access card to a reader device refers in this context to a person taking his/her access card, e.g. an RFID identifier, into reading range of the reader device.

The reader device is connected to an access control unit, which is arranged to open the locking of the door panel if, on the basis of the identification data read from the access card, the person has the access right to move from the second space into the first space. In one embodiment of the invention the access control unit is integrated into the automatic door system, e.g. into the module comprising the aforementioned opening pushbutton and reader device. As a result of the embodiment, the automatic door system can operate as an independent system belonging to the access control.

In one embodiment of the invention the automatic door system comprises an independent power source, e.g. batteries, an accumulator and/or a solar cell. By means of the power source, the components in connection with the automatic door system can be electrified so that the automatic door system does not need an external power supply, e.g. mains current.

In one embodiment of the invention an access card can be read with the reader device also by presenting the access card to the reader device from the side of the first space. As a result of the embodiment, the access control can be improved e.g. by preventing the operation of the opening pushbutton at a certain time of the day/night and by making it necessary for all persons using an automatic door to present their access cards to a reader device regardless of the direction of travel.

In one embodiment of the invention the opening pushbutton is a touch-sensitive switch. As a result of the embodiment, the reliability of an automatic door can be improved and a very compact structure can be achieved for the module formed by the opening pushbutton and reader device.

In one embodiment of the invention the door panel is fabricated of essentially translucent material and the module formed by the opening pushbutton and reader device is fixed on the side of the first space of the door panel or wall structure in such a way that the reader device is visible through the translucent material from the side of the second space. If necessary, the location of the reader device can be indicated with a sticker or with another corresponding marking to be glued to the surface on the side of the second space of the wall structure or door panel. As a result of the embodiment, installation is considerably facilitated because no cavities are needed for the module of the opening pushbutton and reader device, but instead it can be affixed to the surface of the door panel or of the wall structure on the side of the first space.

By means of the invention significant advantages are achieved with respect to prior-art solutions. Installation of an automatic door system is facilitated and speeded up because the opening pushbutton and the access card reader device that are required for access control can be installed as a single module, without even making any cavities in the wall structures for the aforementioned module. An automatic door system can be made into a very independently functioning system by integrating into it its own power source and/or the components required by the access control unit. By disposing the module formed by the opening pushbutton and the reader device in the door panel, the retrofitting of an automatic door system becomes easier and faster than before because the amount of installation work decreases.

### LIST OF FIGURES

In the following, the invention will be described in detail by the aid of a few examples of its embodiments, wherein:

FIGS. 1a and 1b present one automatic door system according to the invention, and

FIG. 2 presents another automatic door system according to the invention.

### DETAILED DESCRIPTION OF THE INVENTION

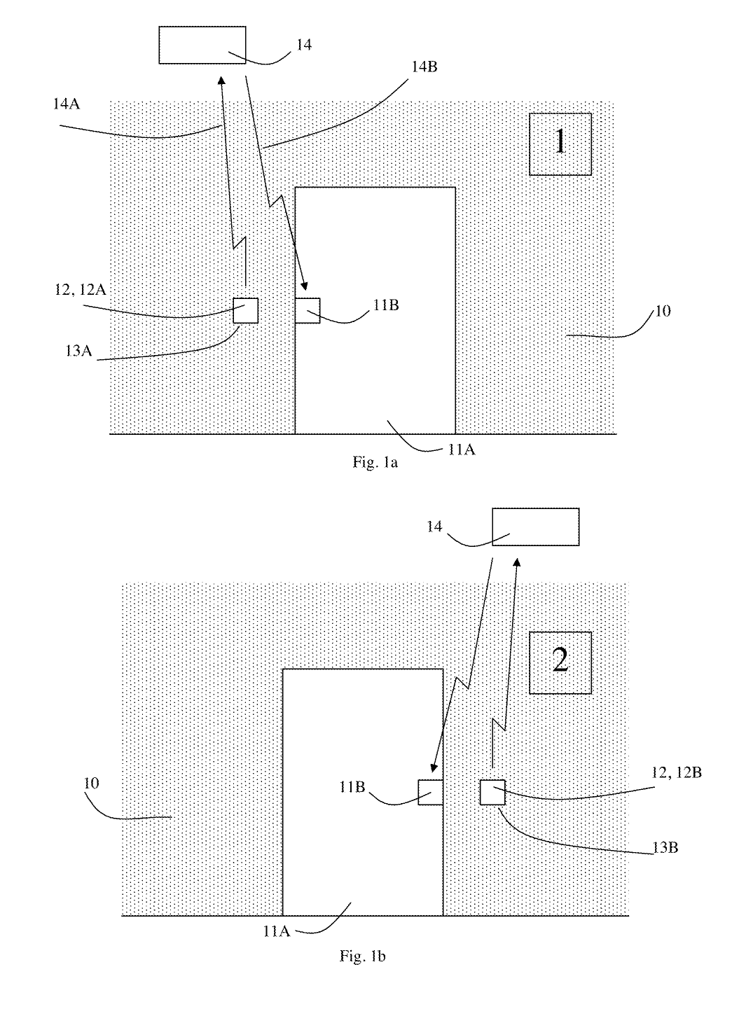

FIG. 1a presents one automatic door system according to the invention as viewed from the side of the first space, and FIG. 1b as viewed from the side of the second space. In FIGS. 1a and 1b, a wall structure 10 divides the space in the building into a first space and a second space. A door panel 11A of the automatic door system is installed in connection with the wall structure. The door panel is provided with a locking device 11B. The locking device is e.g. an electrical lock, which opens only when controlled by an external opening signal. The locking device can also be an actuator, which automatically opens and/or closes the door panel controlled by an external opening signal or closing signal. An opening pushbutton 12A and an access card reader device 12B are integrated into a single module 12 and are disposed at a point 13 in the wall structure, either directly onto the wall surface or in a cavity made in the wall surface. The opening pushbutton 12A is on the side of the first space in such a way that a person in the first space can press the opening pushbutton, in which case the locking device 11B receives an opening signal sent by the module 12. The module 12 can send an opening signal to the locking device either directly or data goes from the opening pushbutton to the access control unit 14, which sends an opening signal to the locking device 11B. Data transfer between the module 12, the access control unit and the locking device can occur via a wired and/or wireless data transfer connection 14A, 14B. The reader device 12B is disposed in FIG. 1b in such a way that a person in the second space can present his/her access card to the reader device, in which case the reader device reads the identification data comprised in the access card and transmits it to the access control unit 14, e.g. using a wireless data transfer connection. The access control unit checks whether, on the basis of the identification data read from the access card, the person has a valid access right to move from the second space into the first space. If the aforementioned access right is valid, the access control unit transmits an opening signal to the locking device 11B, e.g. using a wireless data transfer connection. A backlight, which can be controlled on for a moment to indicate that the access right has been accepted, can also be integrated in connection with the module 12. By implementing the backlight as a two-color one, a person can be notified of an accepted access right e.g. with a green backlight, and of a rejected access right e.g. with a red backlight. Means for reading an access card and/or for generating auditive messages relating to access rights can also be integrated in connection with the module 12.

The opening pushbutton 12A can be a conventional mechanical pushbutton or a touch-sensitive button.

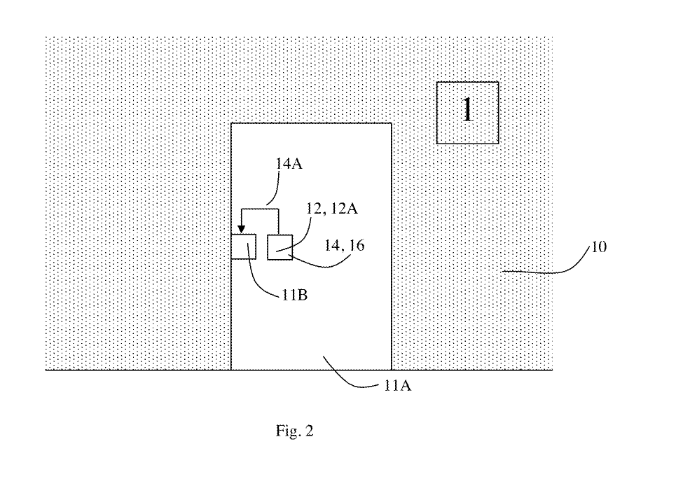

FIG. 2 presents an automatic door system according to the invention in which the module 12 is integrated into the door panel 11A. The door panel is of translucent material and the module 12 is fixed directly to the surface of the door panel on the side of the first space without making a cavity in the door panel. At the point of the module 12 a sticker indicating the access card reader device is glued onto the surface of the door panel 11A on the side of the second space. When a person takes his/her access card to the point 13 indicated by the sticker on the door panel 11A, the reader device 12B reads the identification data of the access card through the door panel and transmits the data to the access control unit 14. The electronics units implementing the functions of the access control unit 14 is integrated into the module 12. The access control unit is in this case an independent system applicable to the access control of one automatic door, in which system data, such as e.g. the identification data of an access card (e.g. ID number, period of validity of the access card), specifying the access rights of the people using the automatic door is recorded. If on the basis of the identification data, e.g. the aforementioned ID number, read from the access card of a person there is an access right from the second space into the first space, the access control unit 14 sends an opening signal 14A to the locking device 11B, in which case the person can move from the second space into the first space via the door 11A.

According to one embodiment of the invention the reader device is also able to read an access card that a person in the first space presents to the reader device. In this case the access control unit 14 can be programmed to function e.g. in such a way that at certain times of the day/night, e.g. at nighttime, the opening pushbutton 12A will not open the locking device 11B, but instead also a person in the first space must present his/her access card to the reader device 12B, if he/she wants to move from the first space into the second space at the aforementioned time.

The invention is not only limited to be applied to the embodiments described above, but instead many variations are possible within the scope of the inventive concept defined by the claims below.

1. Automatic door system, which comprises: a door panel, which is disposed in connection with a wall structure, which wall structure separates a first space and a second space from each other; a locking device for the door panel; an opening pushbutton for the locking means; and an access control unit, in connection with which is an access card reader device, wherein the opening pushbutton and the reader device are integrated into a single module, which is disposed as a single entity in a wall structure or in a door panel.

2. Automatic door system according to claim 1, wherein the opening pushbutton is disposed in such a way that a person on the side of the first space can press the opening pushbutton and the reader device is disposed in such a way that a person on the side of the second space can present his/her access card to the reader device for reading the identification data comprised in the access card.

3. Automatic door system according to claim 1, wherein the reader device is connected to an access control unit, which is arranged to open the locking means if, on the basis of the identification data read from the access card presented by a person, the person has the access right to move from the aforementioned second space into the aforementioned first space.

4. Automatic door system according to claim 1 above, wherein the automatic door system comprises a power source.

5. Automatic door system according to claim 1 above, wherein the access control unit is integrated in connection with the aforementioned module.

6. Automatic door system according to claim 1 above, wherein the aforementioned module is installed in a door panel.

7. Automatic door system according to claim 1 above, wherein an access card can be read with the reader device also from the side of the first space.

8. Automatic door system according to claim above, wherein the opening pushbutton is a touch-sensitive switch.
